(19) United States
(12) Patent Application Publication
(10) Pub. No.: US 2013/0082649 A1
(43) Pub. Date: Apr. 4, 2013

(54) WIRELESS CHARGING SYSTEM

(71) Applicants: Hyun Seok LEE, Seoul (KR); Young Seok YOON, Gyeonggi-do (KR); Sam Ki JUNG, Gyeonggi-do (KR); Eung Ju KIM, Gyeonggi-do (KR)

(72) Inventors: Hyun Seok LEE, Seoul (KR); Young Seok YOON, Gyeonggi-do (KR); Sam Ki JUNG, Gyeonggi-do (KR); Eung Ju KIM, Gyeonggi-do (KR)

(21) Appl. No.: 13/619,857

(22) Filed: Sep. 14, 2012

(30) Foreign Application Priority Data
Sep. 30, 2011 (KR) 10-2011-0100221

(51) Int. Cl. H02J 7/00

(52) U.S. Cl. 320/108

(57) ABSTRACT

Disclosed herein is a wireless charging system that includes a transmission device including a primary coil and a reception device including a secondary coil, wherein the transmission device detects an input signal provided from the primary coil to generate an output signal in the form of a pulse, and compares the level of the generated output signal with a reference voltage to generate a detection signal for determining the presence or absence of the reception device. The wireless charging system does not require an analog-to-digital converter (ADC), eliminating the necessity of using an ADC chip or a high-priced control circuit including an ADC block, thus reducing a material cost of the system. In addition, since the wireless charging system does not require a software algorithm for processing an ADC signal, the performance can be improved.

### CROSS REFERENCE(S) TO RELATED APPLICATIONS

This application claims the benefit under 35 U.S.C. Section 119 of Korean Patent Application Serial No. 10-2011-0100221, entitled “Wireless Charging System” filed on Sep. 30, 2011, which is hereby incorporated by reference in its entirety into this application.

### BACKGROUND OF THE INVENTION

1. Technical Field The present invention relates to a wireless charging system and, more particularly, to a wireless charging system capable of reducing fabrication cost.

2. Description of the Related Art

Recently, research on a wireless power transfer technique that allows convenient supplying or charging power without having connection of an electric wire to various electronic devices has been actively ongoing, such that the field for the wireless power transfer technology is rapidly growing.

The wireless power transfer technique has expended from a scheme of wirelessly charging personal terminals to a technique of wirelessly charging vehicle batteries.

The wireless power transfer technique field is classified into three schemes, i.e., an inductive coupling scheme, an evanescent wave resonance scheme, and a radio frequency (RF) scheme, and currently, the inductive coupling scheme is commonly used because it is very effective.

The inductive coupling scheme has the same basic principle as that of a transformer, and, in a wireless charging system, primary and secondary coils of a transformer are separately used. Namely, the primary coil is used in a charging device (referred to as a ‘transmission device’, hereinafter) and the secondary coil is mounted in a terminal (referred to as a ‘reception device’, hereinafter) so as to be used.

In designing a wireless charging system using the inductive coupling scheme, an induction of current between coils is closely related to the efficiency of the overall system, so the wireless charging system should be designed in consideration of the coil characteristics and matching of the transmitter and the receiver.

In addition, an unnecessary waste of power at the transmission device's side should be necessarily reduced by determining the presence or absence of the reception device on a transmission device pad; namely, transmitting power when the reception device is present thereon and preventing power supply in the absence of the reception device.

### SUMMARY OF THE INVENTION

An object of the present invention is to provide a wireless charging system capable of reducing fabrication cost.

According to an exemplary embodiment of the present invention, there is provided a wireless charging system that includes transmission device including a primary coil and a reception device including a secondary coil, wherein the transmission device senses an input signal provided from the primary coil to generate an output signal in the form of a pulse, and compares the level of the generated output signal with a reference voltage to generate a detection signal for determining the presence or absence of the reception device.

The transmission device may include a power amplifier driving unit providing power to the primary coil; a controller controlling the power amplifier driving unit in response to the detection signal; and a detection unit generating the detection signal and providing the generated detection signal to the controller.

The detection unit may include: a level determining unit detecting the input signal to generate the output signal in the form of a pulse; and a comparison unit comparing the level of the output signal with a reference voltage and generating the detection signal for determining the presence or absence of the reception device.

The detection unit may further include an isolation unit connected with a front stage of the level determining unit and preventing interference with the power amplifier driving unit due to an introduction of the input signal.

The level determining unit may be a limiter circuit including first and second diodes connected in parallel in different directions.

Bias voltages each having a different level may be applied to the first and second diodes, respectively.

According to an exemplary embodiment of the present invention, there is provided a wireless charging system that includes a transmission device including a primary coil and a reception device including a secondary coil, wherein the transmission device includes a power source unit generating charging power by using an external power source; a power amplifier (PA) driving unit amplifying a high frequency from the charging power generated by the power source unit; a detection unit detecting an input signal provided from the primary coil to generate an output signal in the form of a pulse, and compares the level of the generated output signal with a reference voltage to generate a detection signal for determining the presence or absence of the reception device; and a controller generating a control signal for driving the PA driving unit in response to the detection signal provided from the detection unit.

The detection unit may include: a level determining unit detecting the input signal to generate the output signal in the form of a pulse; and a comparison unit comparing the level of the output signal with a reference voltage and generating the detection signal for determining the presence or absence of the reception device.

The detection unit may further include an isolation unit connected with a front stage of the level determining unit and preventing interference with the power amplifier driving unit due to an introduction of the input signal.

The level determining unit may be a limiter circuit including first and second diodes connected in parallel in different directions.

Bias voltages each having a different level may be applied to the first and second diodes, respectively.

### BRIEF DESCRIPTION OF THE DRAWINGS

FIG. 1 is a schematic block diagram of a wireless charging system according to an exemplary embodiment of the present invention.

FIG. 2 is a detailed block diagram of a detection unit of the wireless charging system according to an exemplary embodiment of the present invention.

FIG. 3 is a view showing a waveform of a signal generated by a level detection unit of the detection unit of FIG. 2.

### DESCRIPTION OF THE PREFERRED EXEMPLARY EMBODIMENTS

Hereinafter, exemplary embodiments of the present invention will be described with reference to the accompanying drawings. However, the exemplary embodiments are described by way of examples only and the present invention is not limited thereto.

In describing the present invention, when a detailed description of well-known technology relating to the present invention may unnecessarily make unclear the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

A wireless charging system according to exemplary embodiments of the present invention will be described with reference to the accompanying drawings.

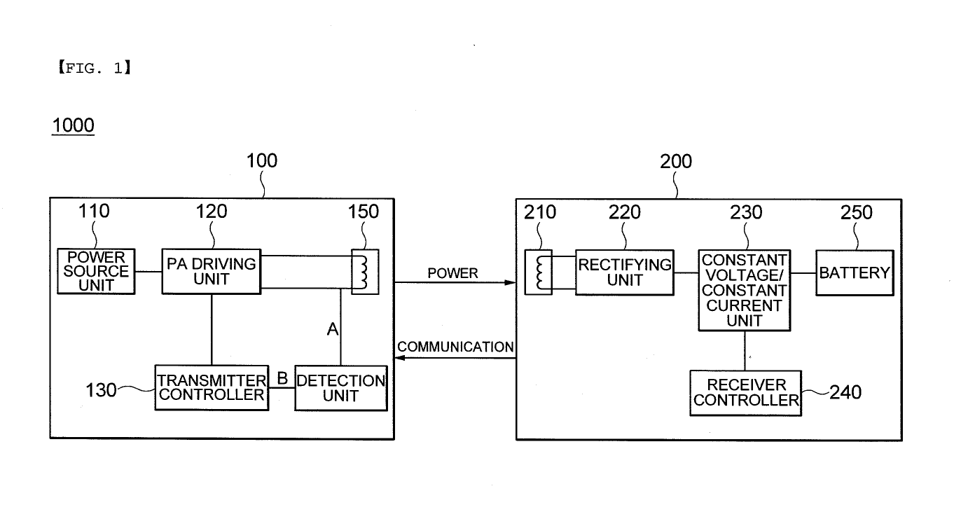

FIG. 1 is a schematic block diagram of a wireless charging system according to an exemplary embodiment of the present invention.

As shown in FIG. 1, a wireless charging system 1000 according to an exemplary embodiment of the present invention includes a transmission device 100 and a reception device 200.

Here, the wireless charging system 1000 according to an exemplary embodiment of the present invention may use an inductive coupling scheme having the same basic principle as that of a transformer.

The transmission device 100 is a means corresponding to a charging device, and transmits optimum power to the reception device 200 to charge the reception device 200.

The transmission device 100 may generate an inductive magnetic field to generate inductive power, and supply the generated inductive power to a mobile device, i.e., the reception device 200.

The transmission device 100 may include a power source unit 110, a power amplifier (PA) driving unit 120, a transmitter controller 130, and a detection unit 140.

The power source unit 110 may generate charging power by using external power source, and supply the generated charging power to the PA driving unit 120.

In general, external power source supplies AC power, so the power source unit 110 may convert the AC power into DC power and transfer the converted DC power to the PA driving unit 120.

The PA driving unit 120 may amplify high frequency from the DC power applied from the power source unit 110 and supply the same to a transmitter coil 150.

In this case, when a DC voltage is applied to a primary coil, i.e., the transmitter coil 150, a static magnetic field is formed in the transmitter coil 150 to allow the transmitter coil 150 to have qualities like an electromagnet, and a magnetic material within the transmitter coil 150 is internally magnetized to have magnetism.

According to the strength of the DC voltage, the DC voltage may be applied up to a secondary coil, i.e., a receiver coil 210, of the reception device 200 in contact with the transmission device 100, and a magnetic material within the receiver coil 210 is also internally magnetized to have magnetism, making the transmitter coil 150 and the receiver coil 210 aligned.

Here, the strength of the DC voltage may be determined by the transmitter controller 130.

In response to a detection signal B detected by the detection unit 140, the transmitter controller 130 may generate a control signal C in the form of a pulse signal for controlling driving of the PA driving unit 120.

In detail, when a detection signal B having a high level is input from the detection unit 140, the transmitter controller 130 may generate the control signal C for activating the PA driving unit 120 and input the generated control signal C to the PA driving unit 120.

Meanwhile, when the detection signal B having a low level is input from the detection unit 140, the transmitter controller 130 may generate the control signal C for deactivating the PA driving unit 120 and input the generated control signal C to the PA driving unit 120.

The detection unit 140 may detect an input signal A introduced from the transmitter coil 150 and generate the detection signal B for determining the presence or absence of the reception device 200.

In detail, upon detecting the input signal A from the transmitter coil 150, the detection unit 140 may generate an output signal in the form of a pulse by using a limiter circuit.

The detection unit 140 may compare the level of the generated output signal and a reference voltage Vref to generate the detection signal B for determining the presence or absence of the reception device 200.

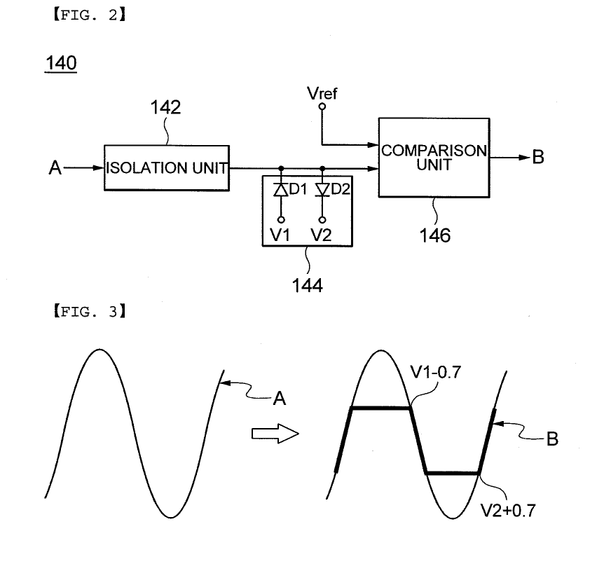

The detection unit 140 according to an exemplary embodiment of the present invention will be described later in detail with reference to FIG. 2.

Meanwhile, the reception device 200 according to an exemplary embodiment of the present invention is an object to be charged, such as a mobile terminal, or the like. When the reception device 200 is required to be charged, it is brought into contact with the transmission device 100, and immediately when the reception device 200 is in contact with the transmission device 100, it may be provided with power from the transmission device 100.

The reception device 200 may include a rectifying unit 220 rectifying a voltage received through the receiver coil 210 from the transmission device 100, a constant voltage/constant current unit 230 generating a constant voltage and a constant current to be charged in a battery 250 by using the rectified voltage received from the rectifying unit 220 and supplying the generated constant voltage and the constant current to the battery 250, and a receiver controller 240 controlling the constant voltage/constant current unit 230.

The wireless charging system 1000 according to an exemplary embodiment of the present invention may change an analog signal into a digital signal by using the limiter circuit.

Thus, the wireless charging system 1000 according to an exemplary embodiment of the present invention does not require an existing analog-to-digital converter (ADC). Thus, since the wireless charging system 1000 does not use an ADC chip (IC) or a high-priced control circuit including an ADC block, a material cost of the system can be reduced.

In addition, since the wireless charging system 1000 does not require a software algorithm for processing an ADC signal, the performance can be improved.

FIG. 2 is a detailed block diagram of a detection unit of the wireless charging system according to an exemplary embodiment of the present invention.

As shown in FIG. 2, the detection unit 140 according to an exemplary embodiment of the present invention may receive the input signal A from the transmitter coil 150 and generate the detection signal B.

The detection unit 140 includes an isolation unit 142, a level determining unit 144, and a comparison unit 146.

The isolation unit 142 serves to prevent interference with the main power, i.e., the PA driving unit 120. For example, the isolation unit 142 may be configured as a transformer.

The level determining unit 144 may determine the level of the input signal A output from the isolation unit 140 to generate an output signal in the form of a pulse.

The level determining unit 144 according to an exemplary embodiment of the present invention may be a limiter circuit including first and second diodes D1 and D2 connected in parallel in the opposite directions.

In detail, the level determining unit 144 determines the level of an input signal according to first and second bias voltages V1 and V2 each having a different level, input to the first and second diodes D1 and D2.

Here, when it is assumed that the first bias voltage V1 is 3V and the second bias voltage V2 is −0.7V, an output signal from the level determining unit 144 may have a pulse signal having a size of 2.3V.

For example, assuming that a turn-on voltage of the first and second diodes D1 and D2 is 0.7V, when the level of the input signal A is +0.7V or higher or −0.7 or lower, the input signal A is discharged from a ground voltage terminal GND through the first and second diodes D1 and D2, without a voltage applied thereto, so the output signal in the form of a pulse having a size of 2.3V as shown in FIG. 3 may be generated.

Here, a maximum level is determined by the first diode D1, which may be, for example, V1−0.7V, and a minimum level is determined by the second diode D2, which may be, for example, V2+0.7v.

The comparison unit 146 compares the reference voltage Vref input from the outside with the voltage of the detection signal B input from the level determining unit 144 and outputs the comparison value to the transmitter controller 130.

In detail, the comparison unit 146 may compare the reference voltage Vref with the detection signal B.

For example, when it is assumed that the reference voltage Vref is 2V, when the detection signal B is greater than the reference voltage Vref, the comparison unit 146 may generate the detection signal B having a high level indicating the presence of the reception device 200 and output the generated detection signal B.

Meanwhile, when the detection signal B is smaller than the reference voltage Vref, the comparison unit 146 may generate the detection signal B having a low level indicating the absence of the reception device 200 and output the generated detection signal B.

In this manner, the detection unit 140 may change the analog signal into the digital signal by using the level determining unit 144.

Thus, the wireless charging system 1000 according to an exemplary embodiment of the present invention does not require an existing analog-to-digital converter (ADC), eliminating the necessity of using an ADC chip or a high-priced control circuit including an ADC block, such that material cost of the system can be reduced.

In addition, since the wireless charging system 1000 does not require a software algorithm for processing an ADC signal, the performance can be improved.

According to the exemplary embodiments of the present invention, in the wireless charging system, an analog signal can be changed into a digital signal by using the limiter circuit.

Thus, the wireless charging system 1000 according to an exemplary embodiment of the present invention does not require an existing analog-to-digital converter (ADC), eliminating the necessity of using an ADC chip (IC) or a high-priced control circuit including an ADC block, thus reducing material cost of the system.

In addition, since the wireless charging system 1000 does not require a software algorithm for processing an ADC signal, the performance can be improved.

Although the preferred exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A wireless charging system that includes a transmission device including a primary coil and a reception device including a secondary coil,
wherein the transmission device detects an input signal provided from the primary coil to generate an output signal in the form of a pulse, and compares the level of the generated output signal with a reference voltage to generate a detection signal for determining the presence or absence of the reception device.

2. The wireless charging system according to claim 1, wherein the transmission device includes:
a power amplifier driving unit providing power to the primary coil;
a controller controlling the power amplifier driving unit in response to the detection signal; and
a detection unit generating the detection signal and providing the generated detection signal to the controller.

3. The wireless charging system according to claim 2, wherein the detection unit includes:
a level determining unit detecting the input signal to generate the output signal in the form of a pulse; and
a comparison unit comparing the level of the output signal with a reference voltage and, generating the detection signal for determining the presence or absence of the reception device.

4. The wireless charging system according to claim 3, wherein the detection unit further includes:
an isolation unit connected with a front stage of the level determining unit and preventing interference with the power amplifier driving unit due to an introduction of the input signal.

5. The wireless charging system according to claim 3, wherein the level determining unit is a limiter circuit including first and second diodes connected in parallel in different directions.

6. The wireless charging system according to claim 5, wherein bias voltages each having a different level are applied to the first and second diodes, respectively.

7. A wireless charging system that includes a transmission device including a primary coil and a reception device including a secondary coil,
wherein the transmission device includes:
a power source unit generating charging power by using an external power source;
a power amplifier (PA) driving unit amplifying a high frequency from the charging power generated by the power source unit;
a detection unit detecting an input signal provided from the primary coil to generate an output signal in the form of a pulse, and compares the level of the generated output signal with a reference voltage to generate a detection signal for determining the presence or absence of the reception device; and
a controller generating a control signal for driving the PA driving unit in response to the detection signal provided from the detection unit.

8. The wireless charging system according to claim 7, wherein the detection unit includes:
a level determining unit detecting the input signal to generate the output signal in the form of a pulse; and
a comparison unit comparing the level of the output signal with a reference voltage and generating the detection signal for determining the presence or absence of the reception device.

9. The wireless charging system according to claim 8, wherein the detection unit further includes:
an isolation unit connected with a front stage of the level determining unit and preventing interference with the power amplifier driving unit due to an introduction of the input signal.

10. The wireless charging system according to claim 8, wherein the level determining unit is a limiter circuit including first and second diodes connected in parallel in different directions.

11. The wireless charging system according to claim 10, wherein bias voltages each having a different level are applied to the first and second diodes, respectively.
